(19) United States
(12) Patent Application Publication
(10) Pub. No.: US 2017/0240017 A1
(43) Pub. Date: Aug. 24, 2017

(54) SYSTEM AND METHOD FOR CONTROLLING DAMPERS OF AN ACTIVE SUSPENSION SYSTEM

(71) Applicant: Tenneco Automotive Operating Company Inc., Lake Forest, IL (US)

(72) Inventors: Bert VANDERSMISSEN, Lovenjoel (BE); Christophe LAUWERYS, Heverlee (BE); Kristoff SIX, Hasselt (BE); Koenraad REYBROUCK, Etterbeek (BE)

(21) Appl. No.: 15/440,059

(22) Filed: Feb. 23, 2017

Related U.S. Application Data
(60) Provisional application No. 62/299,300, filed on Feb. 24, 2016.

(51) Int. Cl. B60G 17/016; B60G 17/019

(52) U.S. Cl. CPC B60G 17/0164; B60G 17/01908; B60G 2300/13; B60G 2500/10; B60G 2600/11; B60G 2800/012; B60G 2400/10; B60G 2400/053; B60G 2400/90

(57) ABSTRACT

A control system and method is disclosed for controlling an active suspension and a leveling system for a motor vehicle. The control system may use estimator, controller and management modules. The estimator module processes measured signals obtained from various components and sensors of the vehicle relating to modal displacements, velocities and accelerations, and calculates derived signals which are used as inputs to the controller module. The controller module calculates the desired damper force for each active damper based on motions of the vehicle body and wheels. The management module translates the desired active damper force into an appropriate set of control signals to control each active damper. These operations are performed for each active damper of the vehicle to control each damper in real time.

### CROSS-REFERENCE TO RELATED APPLICATIONS

This application claims the benefit of U.S. Provisional Application No. 62/299,300, filed on Feb. 24, 2016. The entire disclosure of the above application is incorporated herein by reference.

### FIELD

The present disclosure relates to an active suspension system, and more particularly to various embodiments of active suspension systems that incorporate a leveling system in conjunction with the active suspension system.

### BACKGROUND

This section provides background information related to the present disclosure which is not necessarily prior art.

Suspension systems are provided to filter or isolate the vehicle's body (sprung portion) from the vehicle's wheels and axles (unsprung portion) when the vehicle travels over vertical road surface irregularities as well as to control body and wheel motion. In addition, suspension systems are also used to maintain an average vehicle attitude to promote improved stability of the vehicle during maneuvering. The typical passive suspension system includes a spring and a damping device in parallel with the spring which are located between the sprung portion and the unsprung portion of the vehicle.

Hydraulic actuators, such as shock absorbers and/or struts, are used in conjunction with conventional passive suspension systems to absorb unwanted vibration which occurs during driving. To absorb this unwanted vibration, hydraulic actuators include a piston located within a pressure cylinder of the hydraulic actuator. The piston is connected to one of the unsprung portion or suspension and the sprung portion or body of the vehicle through a piston rod. The pressure tube is connected to the other of the unsprung portion and sprung portion of the vehicle. Because the piston is able to restrict the flow of damping fluid within the working chamber of the hydraulic actuator when the piston is displaced within the pressure cylinder, the hydraulic actuator is able to produce a damping force which counteracts the vibration of the suspension. The greater the degree to which the damping fluid within the working chamber is restricted by the piston, the greater the damping forces which are generated by the hydraulic actuator.

In recent years, substantial interest has grown in automotive vehicle suspension systems which can offer improved comfort and road handling over the conventional passive suspension systems. In general, such improvements are achieved by utilization of an “intelligent” suspension system capable of electronically controlling the suspension forces generated by hydraulic actuators.

Different levels in achieving the ideal “intelligent” suspension system called a semi-active or a fully active suspension system are possible. Some systems control and generate damping forces based upon the dynamic forces acting against the movement of the piston. Other systems control and generate damping forces based on the static or slowly changing dynamic forces, acting on the piston independent of the velocity of the piston in the pressure tube. Other, more elaborate systems can generate variable damping forces during rebound and compression movements of the hydraulic actuator regardless of the position and movement of the piston in the pressure tube.

In addition to the above, there is a need for more advanced and intelligent control systems for controlling an active suspension system of a vehicle in real time. More specifically, there is a growing need for a control system for an active suspension system that can monitor a large plurality of real time inputs relating to modal displacements, velocities and accelerations, for each one of roll, heave and pitch motions experienced by a vehicle, and to generate appropriate control signals for continuously variable solenoid actuator (CVSA) type valves associated independently with each of the dampers.

### SUMMARY

This section provides a general summary of the disclosure, and is not a comprehensive disclosure of its full scope or all of its features.

In one aspect the present disclosure relates to an active suspension system for a vehicle, wherein the vehicle has a plurality of active dampers and a plurality of sensors for providing information on operating states of the vehicle. The system may comprise an estimator module, a controller module and a management module. The estimator module may be configured to receive inputs from the plurality of sensors and to generate a plurality of first outputs including differing body accelerations during operation of the vehicle. The controller module may be in communication with the estimator module and may be configured to receive the plurality of first outputs from the estimator module and to generate a plurality of second output signals for controlling the active dampers. The management module may be configured to receive the second outputs and to calculate actuator signals to be applied to each of the plurality of active dampers.

In another aspect the present disclosure may be directed to an active suspension system for a vehicle having four active dampers and a plurality of sensors for providing information on a plurality of states of the vehicle. The system may comprise an estimator module, optionally a controller module and optionally a management module. The estimator module may be configured to receive inputs from the plurality of sensors and to generate a plurality of first outputs relating to accelerations associated with operation of the vehicle. The controller module may be in communication with the estimator module and may be configured to receive the plurality of first outputs from the estimator module and to generate a plurality of second output signals for controlling the active dampers. The management module may be configured to receive the second outputs and to calculate actuator signals to be applied to each of the plurality of active dampers. The management module may optionally include a separate management module subsystem for each active damper. Each management module subsystem may include optionally a first look-up table for valve control values for controlling at least one valve associated with each of the active dampers to implement a sport mode of operation for the active dampers, and optionally a second look-up table. The second look-up table may be included for valve control values for controlling at least one valve associated with each of the active dampers to implement a touring mode of operation for the active dampers.

In still another aspect the present disclosure may be directed to a method for forming an active suspension system for a vehicle, wherein the vehicle has a plurality of active dampers and a plurality of sensors for providing information on operating states of the vehicle. The method may include using an estimator module, and optionally a controller module, and optionally a management. The estimator module may be configured to receive inputs from the plurality of sensors and to generate a plurality of first outputs including differing body accelerations during operation of the vehicle. The controller module may be configured to be in communication with the estimator module and to receive the plurality of first outputs from the estimator module and to generate a plurality of second output signals for controlling the active dampers. The management module may be configured to receive the second outputs and to calculate actuator signals to be applied to each of the plurality of active dampers.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagrammatic illustration of a vehicle incorporating the leveling system and the active suspension system in accordance with the present disclosure;

FIG. 2 is a schematic view of one of the corner assemblies including the hydraulic actuator illustrated in FIG. 1 illustrating the components of the hydraulic actuator;

FIG. 3 is a schematic view of fluid connection between the hydraulic actuator for the active suspension system and the leveling system;

FIG. 4 is a schematic view of a corner assembly including a hydraulic actuator in accordance with another embodiment of the present disclosure;

FIG. 5 is a high level schematic diagram of an embodiment of an actuator system of the present disclosure configured to be disposed on one axle of a vehicle, and making use of one motor and a pair of pumps which supply fluid to otherwise independent actuator subsystems;

FIG. 6 is a high level schematic diagram of one embodiment of the controller module of FIG. 5;

FIG. 7 is a high level schematic diagram of one embodiment of the management module of FIG. 6 illustrating that the management module, in this example, is comprised of four independent management module subsystems, each being separately associated with a designated one of the dampers; and

FIG. 8 is a high level schematic diagram of one embodiment of one of the management module subsystems illustrating the various look-up tables used by the subsystem.

Corresponding reference numerals indicate corresponding parts throughout the several views of the drawings.

### DETAILED DESCRIPTION

Example embodiments will now be described more fully with reference to the accompanying drawings.

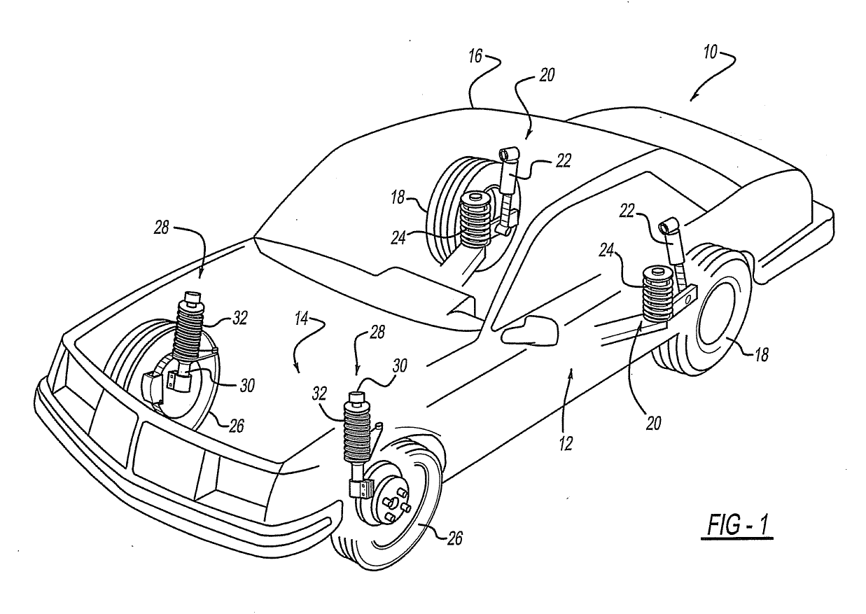

The following description is merely exemplary in nature and is not intended to limit the present disclosure, application or uses. There is shown in FIG. 1 a vehicle incorporating a suspension system having a suspension system in accordance with the present disclosure and which is designated generally by the reference numeral 10. Vehicle 10 comprises a rear suspension 12, a front suspension 14 and a body 16. Rear suspension 12 has a transversely extending rear axle assembly (not shown) adapted to operatively support the vehicle's rear wheels 18. The rear axle assembly is operatively connected to body 16 by means of a pair of corner assemblies 20 which include a pair of shock absorbers 22 and a pair of helical coil springs 24. Similarly front suspension 14 includes a transversely extending front axle assembly (not shown) to operatively support the vehicle's front wheels 26. The front axle assembly is operatively connected to body 16 by means of a second pair of corner assemblies 28 which include a pair of shock absorbers 30 and by a pair of shaped helical coil springs 32. Shock absorbers 22 and 30 serve to dampen the relative motion of the unsprung portion (i.e., front and rear suspensions 12 and 14, respectively) and the sprung portion (i.e., body 16) of vehicle 10. While vehicle 10 has been depicted as a passenger car having front and rear axle assemblies, shock absorbers 22 and 30 may be used with other types of vehicles and/or in other types of applications such as vehicles incorporating independent front and/or independent rear suspension systems. Further, the term “shock absorber” as used herein is meant to be dampers in general and thus will include struts. Also, while front suspension 14 is illustrated having a pair of struts or shock absorbers 30, it is within the scope of the present invention to have rear suspension 12 incorporate a pair of struts or shock absorbers 30 if desired. As illustrated in FIG. 1, shock absorber 22 is separate from spring 24. In this configuration, the adjustable spring seat is disposed between the sprung and unsprung portions of the vehicle. Also, shock absorber 22 and spring 24 can be replaced with corner assemblies 28.

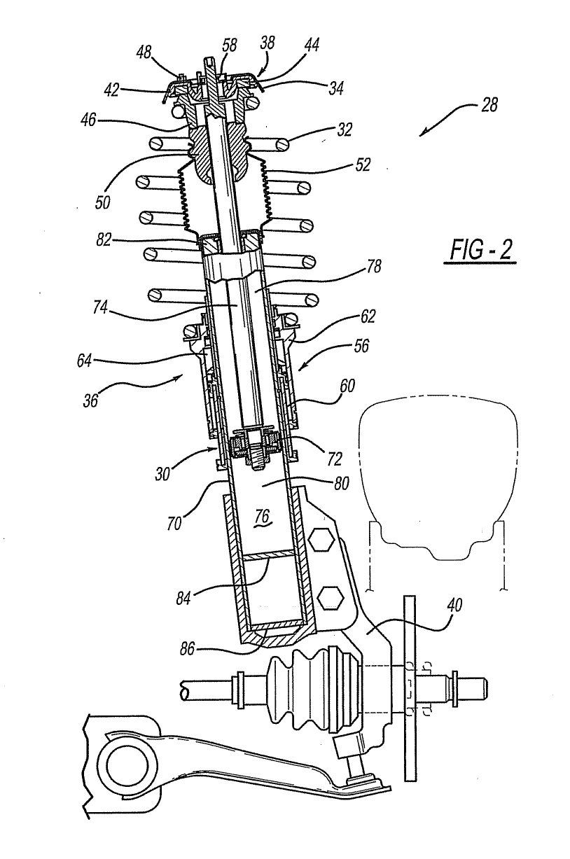

Referring now to FIG. 2, the front corner assembly 28 for vehicle 10 is illustrated in greater detail. Body 16 defines a shock tower 34 comprising sheet metal of vehicle 10 within which is mounted a strut assembly 36 which comprises a telescoping device in the form of shock absorber 30, coil spring 32, a top mount assembly 38, and a knuckle 40 which is part of a wheel assembly. Strut assembly 36 including shock absorber 30, coil spring 32 and top mount assembly 38 are attached to vehicle 10 using shock tower 34. Top mount assembly 38, a part of the sprung portion of the vehicle, comprises a top mount 42, a bearing assembly 44, and an upper spring seat 46. Top mount 42 comprises an integral molded body and a rigid body member, typically made of stamped steel. Top mount assembly 38 is mounted to shock tower 34 by bolts 48. Bearing assembly 44 is friction fit within the molded body of top mount 42 to be seated in top mount 42 so that one side of bearing assembly 44 is fixed relative to top mount 42 and shock tower 34. The second side of bearing assembly 44 freely rotates with respect to the first side of bearing assembly 44, top mount 42, and shock tower 34.

The free rotating side of bearing assembly 44 carries upper spring seat 46 that is clearance fit to the outer diameter of bearing assembly 44. An elastomeric jounce bumper 50 is disposed between upper spring seat 46 and shock absorber 30. Elastomeric jounce bumper 50 comprises an elastomeric material which is protected by a plastic dirt shield 52.

A hydraulic adjustable lower spring seat assembly 56, which is part of the unsprung portion of the vehicle, is attached to shock absorber 30 and coil spring 32. Coil spring 32 is disposed between upper spring seat 46 and lower spring seat assembly 56 to isolate body 16 from front suspension 14. While shock absorber 30 is illustrated in FIG. 2, it is to be understood that shock absorber 22 may also include the features described herein for shock absorber 30.

Prior to the assembly of strut assembly 36 into vehicle 10, the pre-assembly of strut assembly 36 is performed. Elastomeric jounce bumper 50 and plastic dirt shield 52 are assembled to shock absorber 30. Coil spring 32 is assembled over shock absorber 30 and positioned within lower spring seat assembly 56. Upper spring seat 46 is assembled onto shock absorber 30 and correctly positioned with respect to coil spring 32. Bearing assembly 44 is positioned on top of upper spring seat 46, and top mount 42 is positioned on top of bearing assembly 44. This entire assembly is positioned within an assembly machine which compresses coil spring 32 such that the end of shock absorber 30 extends through a bore located within top mount assembly 38. A retaining nut 58 is threadingly received on the end of shock absorber 30 to secure the assembly of strut assembly 36.

Top mount 42 is designed as an identical component for the right and left hand sides of the vehicle, but it has a different orientation with respect to shock absorber 30 and its associated bracketry when it is placed on the right or left side of the vehicle.

Hydraulic adjustable spring seat assembly 56 includes an inner housing assembly 60 attached to shock absorber 30, and an outer housing assembly 62 that is attached to both shock absorber 30, and coil spring 32. Inner housing assembly 60 and outer housing assembly 62 define a fluid chamber 64. When fluid is added to fluid chamber 64, outer housing assembly 62 will move upward along shock absorber 30, as illustrated in FIG. 2. This movement will raise vehicle body 16 with respect to front suspension 14. When fluid is removed from fluid chamber 64, outer housing assembly 62 will move downward along shock absorber 30, as illustrated in FIG. 2. This movement will lower vehicle body 16 with respect to front suspension 14. Fluid chamber 64 is in fluid communication with shock absorber 30 as described below.

Shock absorber 30 is a mono-tube designed shock absorber comprising a pressure tube 70, a piston assembly 72 and a piston rod 74.

Pressure tube 70 defines a fluid chamber 76. Piston assembly 72 is slidably disposed within pressure tube 70 and divides fluid chamber 76 into an upper working chamber 78 and a lower working chamber 80. A seal is disposed between piston assembly 72 and pressure tube 70 to permit sliding movement of piston assembly 72 with respect to pressure tube 70 without generating undue frictional forces as well as sealing upper working chamber 78 from lower working chamber 80. Piston rod 74 is attached to piston assembly 72 and extends through upper working chamber 78 and through an upper end cap 82 which closes the upper end of pressure tube 70. A sealing system seals the interface between upper end cap 82, pressure tube 70, and piston rod 74. The end of piston rod 74 opposite to piston assembly 72 is adapted to be secured to the one of sprung and unsprung mass of vehicle 10. Valving within piston assembly 72 controls the movement of fluid between upper working chamber 78 and lower working chamber 80 during movement of piston assembly 72 within pressure tube 70. Because piston rod 74 extends only through upper working chamber 78 and not lower working chamber 80, movement of piston assembly 72 with respect to pressure tube 70 causes a difference in the amount of fluid displaced in upper working chamber 78 and the amount of fluid displaced in lower working chamber 80. The difference in the amount of fluid displaced is known as the “rod volume” and it is accommodated for by the use of a floating piston 84 as is well known in the art. An end cap 86 seals the end of pressure tube 70.

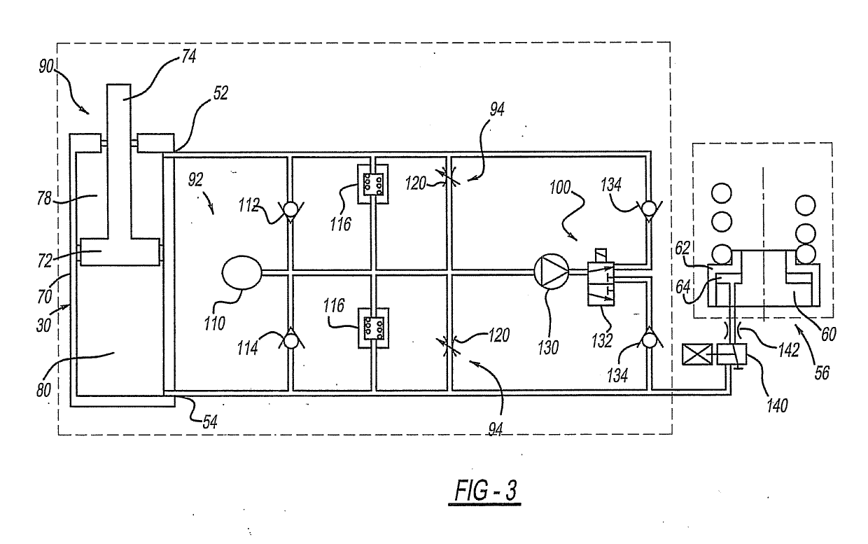

Referring to FIG. 3, a hydraulic actuator assembly 90, which may be also termed a “power pack” and referred to herein as “power pack 90”, comprises shock absorber 30, a low pressure accumulator subsystem 92, one or more pressure divider subsystems 94, and a flow divider subsystem 100.

Low pressure accumulator subsystem 92 comprises a low pressure accumulator 110, a first check valve 112 and a second check valve 114. First check valve 112 allows fluid flow from low pressure accumulator 110 to upper working chamber 78 but prohibits fluid flow from upper working chamber 78 to low pressure accumulator 110. Second check valve 114 allows fluid flow from low pressure accumulator 110 to lower working chamber 80 but prohibits fluid flow from lower working chamber 80 to low pressure accumulator 110. Low pressure accumulator 110 is connected to a pair of blow-off valves 116, the one or more pressure divider subsystems 94, and flow divider subsystem 100.

The two pressure divider subsystems 94 illustrated in FIG. 3 include a rebound pressure divider subsystem 94 (the upper pressure divider subsystem) and a compression pressure divider subsystem 94 (the lower pressure divider subsystem). Each pressure divider subsystem 94 comprises a controlled restriction 120. In rebound pressure divider subsystem 94, controlled restriction 120 is located between upper working chamber 78 and flow divider subsystem 100, and between upper working chamber 78 and low pressure accumulator 110. In the compression pressure divider subsystem 94, controlled restriction 120 is located between lower working chamber 80 and flow divider subsystem 100, and between lower working chamber 80 and low pressure accumulator 110.

Pressure divider subsystem 94 creates a requested pressure in upper working chamber 78 and/or lower working chamber 80.

Flow divider subsystem 100 comprises a pump 130, a hydraulic switch valve 132 and a pair of check valves 134. Flow divider subsystem 100 controls the hydraulic energy from pump 130. Pump 130 receives fluid from low pressure accumulator 110. Fluid from pump 130 is directed to hydraulic switch valve 132. Hydraulic switch valve 132 can guide fluid flow to upper working chamber 78 and/or lower working chamber 80 depending on where it is needed. Hydraulic switch valve 132 can also divide the flow between upper working chamber 78 and lower working chamber 80 in a continuously controlled manner. While hydraulic switch valve 132 is illustrated using a symbol of a switch valve, this is not intended to limit the disclosure. Check valves 134 prohibit fluid flow from upper working chamber 78 and lower working chamber 80 to flow divided subsystem 100.

As illustrated in FIG. 3, fluid chamber 64 of hydraulic adjustable spring seat assembly 56 is in fluid communication with hydraulic actuator assembly 90 (i.e., the power pack). This connection allows for the changing of the static vehicle height and the compensation for static load changes by adjusting the height of body 16 with respect to front suspension 14 based upon the fluid pressures within hydraulic actuator assembly 90.

When an increased static (or quasi-static) push-out force must be created in shock absorber 30, hydraulic actuator assembly 90 will deliver this force by increasing the pressure in lower working chamber 80. This will be accomplished by having pump 130 provide high pressure fluid to lower working chamber 80 through hydraulic switch valve 132. When the fluid pressure in lower working chamber 80 rises above the static pressure in fluid chamber 64 of hydraulic adjustable spring seat assembly 56, a control valve 140 can be opened to allow fluid flow to enter fluid chamber 64 of hydraulic adjustable spring seat assembly 56. The fluid pressure in fluid chamber 64 will push outer housing assembly 62 upwards to raise vehicle body 16 and gradually take over the static load for vehicle body 16 from hydraulic actuator assembly 90. A restriction 142 limits the amount of fluid flow that leaves hydraulic actuator assembly 90 preserving pressure levels in hydraulic actuator assembly 90.

For the final adjustment, the fluid pressure in both upper working chamber 78 and lower working chamber 80 will be increased to maintain enough pressure to move hydraulic adjustable spring seat assembly 56 to its new position. When this final position of hydraulic adjustable spring seat assembly 56 is reached, control valve 140 will be closed.

When the static (or quasi-static) push-out force in lower working chamber 80 must be lowered, first the fluid pressure in upper working chamber 78 will be increased by providing pressurized fluid from pump 130 through hydraulic switch valve 132. This will provide a counter-acting force. The pressure in lower working chamber 80 will be low, near the pressure in low pressure accumulator 110. Control valve 140 can be opened and fluid will flow from fluid chamber 64 of hydraulic adjustable spring seat assembly 56 into the low pressure side of hydraulic actuator assembly 90. Restriction 142 will limit this flow to a level that is not distortive to the function of hydraulic actuator assembly 90. Gradually the counter-acting rebound force generated by hydraulic actuator assembly 90 will be reduced. Control valve 140 is preferably a low-flow bi-directional normally-closed hydraulic valve.

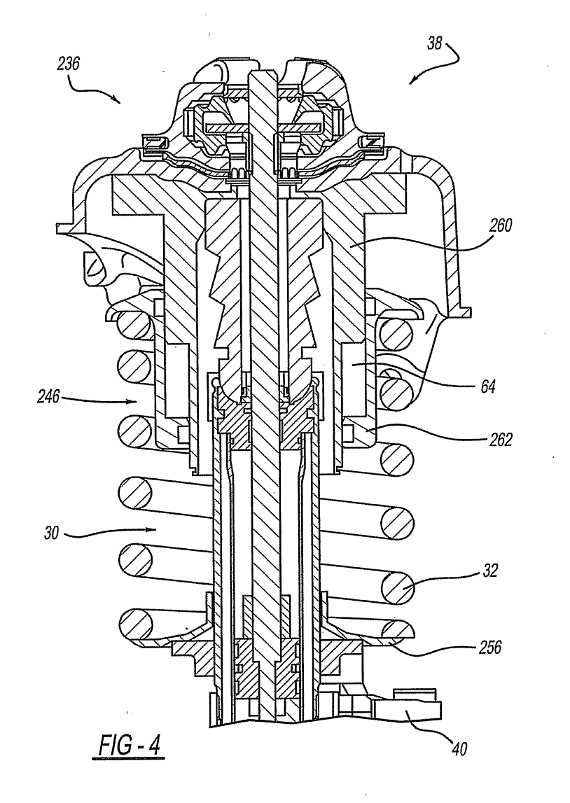

The present disclosure is not limited to hydraulic adjustable lower spring seat assembly 56. FIG. 4 illustrates a strut assembly 236. Strut assembly 236 comprises shock absorber 30, coil spring 32, top mount assembly 38, a part of the sprung portion of the vehicle, and knuckle 40 which is a portion of the unsprung portion of the vehicle. The above discussion regarding strut assembly 36 in relation to top mount assembly 38 applies to strut assembly 236 also. The difference between strut assembly 236 and strut assembly 36 is that upper spring seat 46 has been replaced with upper spring seat assembly 246 and lower spring seat assembly 56 has been replaced with lower spring seat 256.

Upper spring seat assembly 246 is a hydraulically adjustable spring seat assembly which is attached to top mount assembly 38. Coil spring 32 is disposed between upper spring seat assembly 246 and lower spring seat 256. Hydraulic adjustable spring seat assembly 246 includes an inner housing assembly 260 attached to top mount assembly 38 and an outer housing assembly 262 that is attached to both inner housing assembly 260 and coil spring 32. Inner housing assembly 260 and outer housing assembly 262 define fluid chamber 64. When fluid is added to fluid chamber 64, outer housing assembly 262 will move downward along inner housing assembly 260, as illustrated in FIG. 4. This movement will raise vehicle body 16 with respect to front suspension 14. When fluid is removed from fluid chamber 64, outer housing assembly 262 will move upward along inner housing assembly 260, as illustrated in FIG. 4. This movement will lower vehicle body 16 with respect to front suspension 14. Fluid chamber 64 is in fluid communication with shock absorber 30 as described above.

The operation and function of hydraulically adjustable spring seat assembly 246 in conjunction with hydraulic actuator assembly 90 is the same as discussed above for adjustable spring seat assembly 56. FIG. 4 represents the adjusting of the upper spring seat rather than the lower spring seat illustrated in FIG. 2.

The advantages of the systems described above include a low cost addition of static load leveling, and height adjustment capability to the active suspension system, and the ability to lower energy consumption, and increase roll control performance in long corners of hydraulic actuator assembly 90.

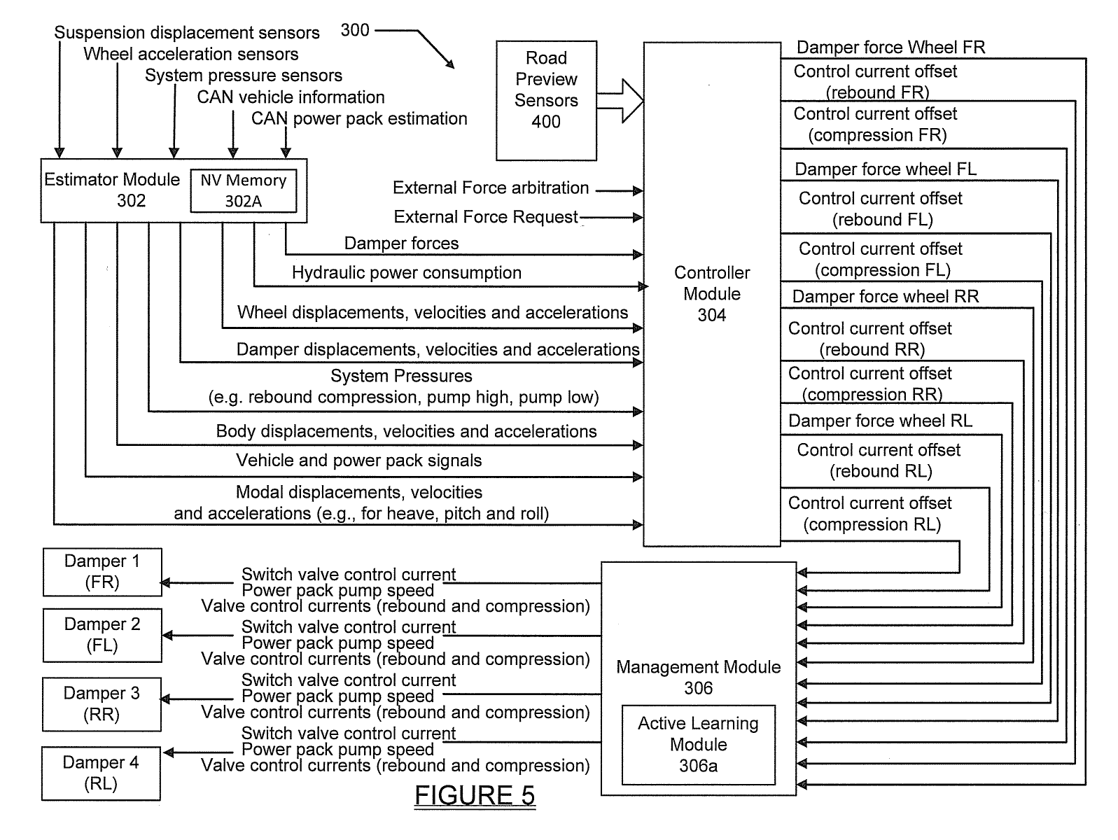

Referring now to FIGS. 5-8, one embodiment of an electronic control system 300 is shown for controlling the active dampers 30a′-30d′ (i.e., shock absorbers) of an active suspension system such as described above in connection with FIGS. 1-4. Thus, each of dampers 30′a-30d′ shown in FIG. 5 may be similar or identical in construction to shock absorber 30 shown in FIGS. 2 and 4. The system 300 is shown having the capability to independently, actively control four dampers 30a′-30d′, but it will be appreciated that the system 300 may be modified to accommodate a lesser or greater number of dampers. In most modern day vehicle applications, however, it is anticipated that the system 300 will be used to actively control four dampers. It will be appreciated that by “actively control” it is meant that the system 300 is able to input energy into each damper 30a′-30d′ to counter or offset the forces input/induced into the dampers 30a′-30d′ of the system 300 by the road and/or to actively control and/or modify the performance capability of the damper 30a′-30d′, in real time, to best meet particular driving conditions or maneuvers. Thus, energy may be input to one particular damper 30a′-30d′ when the vehicle is performing a sharp cornering maneuver to prevent a corner of the vehicle from dipping down during the cornering maneuver.

With specific reference to FIG. 5, the system 300 can be seen to include an estimator module 302, a controller module 304 and a management module 306. Each of the modules 302-306 have comprise both hardware and software components, and may be controlled by separate processors, or optionally by a single processor. The following signals are read from the vehicle's on-board communications network, for example a CAN network, to gather information about the vehicle state, driver intentions and ongoing maneuvers, for use by the estimator module 302:

Lateral acceleration;

Brake pressure;

Individual wheel speeds;

Vehicle speed;

Throttle pedal position;

Steering wheel angle;

Steering wheel angle rate; and

Engine rpm.

And while the following description is focused around a CAN network, it will be appreciated that virtually any other suitable type of vehicle communications network may be used, for example a FlexRay bus.

The estimator module 302 also receives a plurality of inputs from suspension displacement sensors, wheel acceleration sensors, system pressure sensors CAN (controller area network) supplied vehicle information and CAN power pack estimation. Using the location information of the vehicle center of gravity, and the locations of the body acceleration sensors with respect to the vehicle center of gravity, a coordinate transformation is performed and a high-pass filtering is applied to translate the three vertical body acceleration sensor signals into heave, pitch and roll modal accelerations. This calculation assumes that the vehicle body is one rigid body. The high-pass filtering is applied to remove any sensor signal offsets due to mounting tolerances, vehicle attitude changes or temperature effects. The modal accelerations are integrated over time and again high-pass filtered to calculate the modal velocities. In turn, the modal velocities are integrated and high-pass filtered to calculate the modal displacements.

The estimator module 302 further calculates vehicle body corner accelerations by high-pass filtering the body acceleration sensor signals. Vehicle body corner velocities are calculated by integrating and high-pass filtering the vehicle body corner accelerations. Wheel accelerations are calculated by high-pass filtering the wheel acceleration sensor signals. Wheel velocities are calculated by integrating and high-pass filtering the wheel accelerations. Damper displacements are calculated by high-pass filtering the suspension displacement sensor signals. Based on these damper displacements and the locations of the damper top mounts with respect to the vehicle center of gravity, the heave vertical displacement and pitch and roll angles with respect to ground are calculated.

The estimator module 302 processes the measured sensor signals and calculates, using algorithms stored in a non-volatile memory, derived signals from them to serve as input signals for the controller module 304. The estimator module 302 uses the foregoing inputs to generate outputs relating to damper forces; hydraulic power consumption; wheel displacements, velocities and accelerations; system pressures (e.g., rebound, compression, pump high, pump low); body displacements, velocities and accelerations; vehicle and power pack signals; and modal displacements, velocities and accelerations (e.g., for heave, pitch and roll movements). The outputs of the estimator module are shown in FIG. 5.

Processing of Power Pack CAN Signals

It will be noted that the CAN interface with the power pack is very much dependent on the actual power pack type and needs to be defined in cooperation with the power pack supplier. The power pack should at least be able to receive a motor speed request from the suspension control system and provide feedback to the suspension control systems about actual motor speed, operational status, and any detected fault modes.

Calculation of Damper Forces and Hydraulic System Properties

When calculating damper forces and hydraulic system properties, it will also be appreciated that the damper forces are calculated using the rebound and compression pressures measured in the damper and the areas defined by the piston and rod diameters. Also, the total pressure drop over the hydraulic power pack is calculated as the difference of the pump outlet and inlet pressures.

Calculation of Steering Metrics

In addition to the above, the calculation of steering metrics may be performed. This may involve determining the actual roll moment split between the front and rear axles of vehicle. This may be determined from the actuator forces, taking into account the damper motion ratios and front and rear axle track widths of the vehicle.

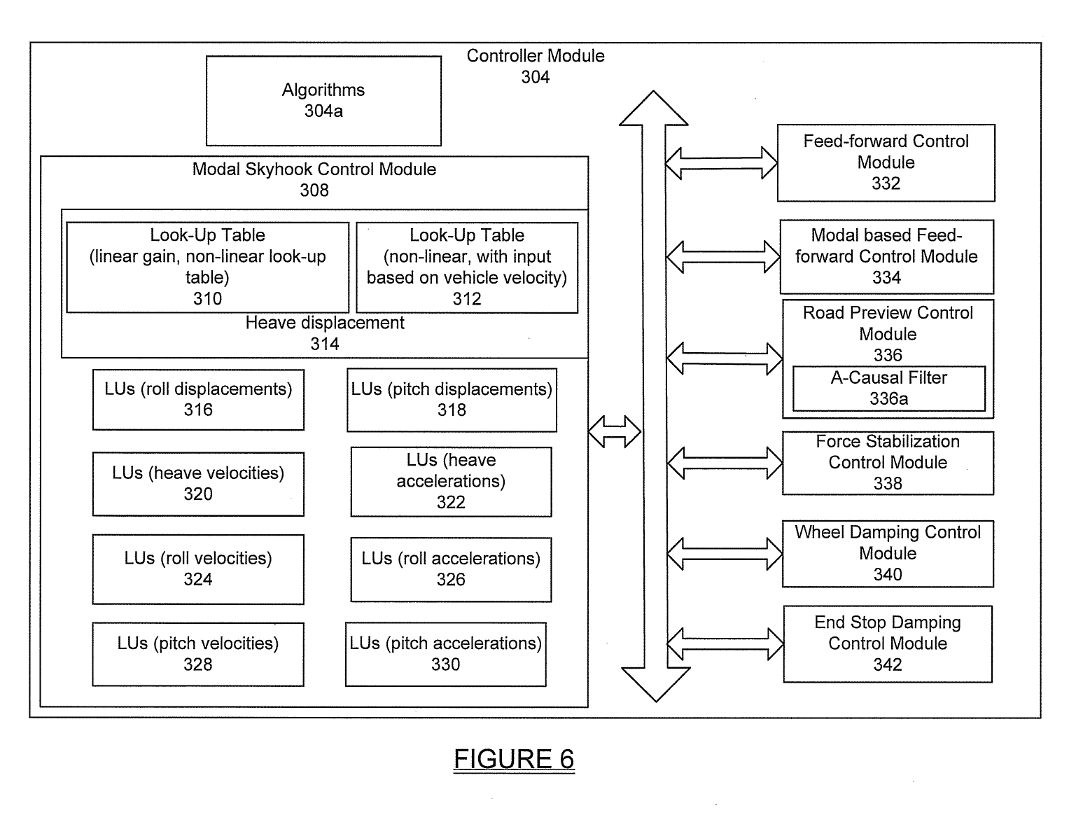

The controller module 304 makes use of at least one, but preferably a plurality of, algorithms 304a (shown in FIG. 6) that operate to calculate the desired damper forces based on the motions of the vehicle body and wheels as measured by the sensors or calculated by the estimator module 302. Other inputs to the controller 304a may be the signals available via the vehicle CAN network. In addition to the desired damper forces, desired control current offsets are also calculated to increase the damping during specific events. The specific outputs of the controller module 304 are shown in FIG. 5. The various subsystems of the controller module 304 will now be described more fully. The control algorithms 304a also enable the controller module 304 to receive inputs from other systems which are not necessarily vehicle dynamics related. For example, the controller 304 module and its stored algorithms 304a may be used to receive inputs to help control the vehicle in a manner to enhance the emotional driving experience of the vehicle operator. In one example, this may be tied to a genre of music that the controller 204 is informed the driver is listening to (e.g., “Easy Listening”). External force arbitration and external force requests inputs to the controller module 304.

Modal (“Skyhook”) Control Module

Typically, in controlled damping systems which use a skyhook-style control methodology, the control focuses on damping: generating a damping force which is function of the (modal) velocity. Because the presently described system and method is a full-active system, the need for a relative velocity between wheel and car body in order to be able to generate a force does no longer apply. The present system and method has an energy source in the form of the hydraulic power pack 90, which means the present system and method is able to generate forces and suspension movements independently from the wheel and body motions. Therefore, the system and method of the present disclosure not only controls modal damping, but also modal stiffness by generating forces which are functions of the modal displacements, or modal ‘inertia’ forces which are functions of the modal accelerations. This control based on modal displacements or accelerations is believed to be unique in the field of active suspension systems.

The damping control systems described in the prior art either describe linear relations between the modal velocities and the modal damping forces, or non-linear control strategies, but not apply non-linear control strategies to modal skyhook control, or either don't give details about the exact relation between modal quantities and the modal forces derived from them. It has been determined by the co-inventors that this relationship needs to be tunable in a flexible and non-linear way in order to achieve the optimum comfort levels and “natural” road feel while travelling in a vehicle. This challenge is addressed by using look-up tables by which it is very convenient to apply a non-linear relation between modal (displacement, velocity or acceleration) inputs and modal force outputs.

As shown in FIG. 6, the controller module 304 includes a modal skyhook control module 308. The modal skyhook control module 308 has as its principal objective to ensure the comfort of passengers in the vehicle 10 by keeping the vehicle body as stable as possible, limiting its motion amplitude and ensuring that any movements happen in a smooth and rounded way, without generating acceleration spikes or sudden disturbances.

The modal skyhook control module 308 has as inputs the modal displacements (i.e., heave, roll and pitch displacements), modal velocities (i.e., heave, roll and pitch velocities) and modal accelerations (i.e., heave, roll and pitch accelerations), in addition to the overall vehicle velocity. For each of these signals independently, a linear gain, a non-linear look-up table 310, and a non-linear look-up table 312 based on vehicle velocity are provided. The look-up tables 310 and 312 are available to tune the relation between the input signal and the calculated desired modal force. For example, for the modal heave velocity input, three tunable parameters are available:

1) A linear gain, converting the modal heave velocity into a desired modal heave force.

2) The non-linear look-up table 310 having as input the modal heave velocity and as output a gain factor which is multiplied with the linear gain mentioned above. This look-up table 310 allows the relation between modal heave velocity and modal heave force to be shaped in a non-linear way, so the sensitivity of the modal heave force can be adjusted over the range of the modal heave velocity.

3) The non-linear look-up table 312 having as an input the vehicle velocity, and its output being a gain factor which is multiplied with the outputs of the linear gain and the other non-linear look-up table 310 mentioned above. This look-up table 312 allows the modal heave force to be a function of the vehicle velocity so the damping in the suspension can be increased when the vehicle 10 is driving faster to ensure vehicle stability at higher speeds.

It will be appreciated that while FIG. 6 only explicitly illustrates the two look-up tables 310 and 312 as part of subsystem 314 being used for determining heave displacement, that separate groups of look-up tables 316-330 are incorporated in the modal skyhook control module 308 to handle displacements, velocities and accelerations for each of the modal heave, pitch and roll. Thus, each of the look-up tables 316-330 incorporates two separate look-up tables such as look-up tables 310 and 312. Modal skyhook control over both modal displacements and modal accelerations is a particular advantage that the Modal skyhook control module 308 provides, relative to prior developed Modal Skyhook control systems.

The controller module 304 also includes a feed-forward control module 332. The feed-forward control module 332 calculates additional pitch and roll moments based on driver inputs detected via the signals on the vehicle CAN network. The desired roll moment is calculated based on steering wheel angle and the vehicle velocity. Two non-linear look-up tables (not shown) allow the feed-forward control module 332 to calibrate the sensitivity of the desired roll moment with respect to the steering wheel angle and the vehicle velocity. Using a steering dynamics model, the lateral acceleration is estimated and fed into a tunable look-up table in series with a linear gain to calculate the desired roll moment.

The desired pitch moment is calculated by the feed-forward control module 332 based on the sensed brake pressure and the vehicle velocity. A non-linear look-up table allows the feed-forward control module 332 to calibrate the sensitivity with respect to the vehicle velocity, and a linear gain allows the module 332 to calibrate the sensitivity with respect to the brake pressure. The output of this look-up table and linear gain are multiplied with each other and then scaled by another tunable gain factor to calculate the desired pitch moment.

The modal forces (heave force, pitch moment and roll moment) of the modal skyhook control module 308 and the feed-forward control module 332 described above are summed together and then distributed over the four dampers using a coordinate transformation. The coordinate transformation takes into account the position of the vehicle center of gravity and the locations of the damper top mounts. The heave force in this example is split equally between the front and rear axles of the vehicle 10. The pitch and roll moments are distributed over the front and rear axles using two independently tunable split factors. The calculated axle forces in this example are equally split between left and right dampers on each axle. The ability to tune heave, pitch and roll using Modal skyhook control in a non-linear manner is an especially valuable control feature.

The controller module 304 further includes a modal based feed-forward control module 334. The modal based feed-forward control module 334 is an alternative to the feed-forward control module 332 described above. Using a vehicle model, the modal based feed-forward control module 334 calculates actuator forces at the wheel which are necessary to achieve a target pitch angle with respect to longitudinal acceleration and a target roll angle with respect to lateral acceleration.

The longitudinal acceleration is calculated by differentiating and low-pass filtering the vehicle velocity. The steering wheel angle and vehicle velocity are inputs to a vehicle model incorporating data about a.o. vehicle mass and geometry parameters, suspension, spring and tire data. This model is used to estimate the lateral acceleration of the vehicle 10. This lateral acceleration and the calculated longitudinal acceleration are then used to determine the necessary steady-state damper force requests to achieve the target pitch and roll behavior of the vehicle 10. These targets can be specified through two tunable look-up tables: a target pitch map specifying the desired pitch angle for a certain longitudinal acceleration and a target roll map specifying the desired roll angle for a certain lateral acceleration.

The controller module 304 further includes a road preview control module 336 which may make use of an A-causal filter 336a. The term ‘A-causal’ is used to refer to the fact that the A-causal filter 336a uses information about the road profile ahead, before features of the road profile impact the wheels or the suspension and are able to be measured by acceleration or displacement sensors in the vehicle. Of course this information needs to be made available by another sensor system on the vehicle which scans the road profile ahead using, for example and without limitation, a camera, a laser, a forward looking infrared (“FLIR”) sensor, a radar system, or any other form of forward looking sensor/scanner, which are all grouped collectively under the term “road preview sensors” 400 in FIG. 5. In practice, the controller module 304 may receive signals from two or more of such sensors and processes these signals to determine the road profile height at some distance (e.g. 10-100 meters) ahead of the vehicle in the vehicle's assumed path of travel. The A-causal filter 336a will read in this road profile height and the road preview module 336 will output desired actuator forces to minimize the impact of the road inputs on the vehicle's behavior. The characteristics of this A-causal filter 336a may be optimized using off-line laboratory and/or computer based simulations.

The road preview control module 336 therefore calculates desired actuator forces based on available road preview information. Road preview information can be acquired using sensors (e.g., optical sensors) or techniques to scan the road profile in front of the vehicle 10 while the vehicle is moving. The road preview information is, for each wheel, independently filtered by the A-causal filter 336a, of which the frequency and damping can be adjusted, depending on how far the sensor(s) is/are looking ahead and also on the vehicle speed. This filtered road preview signal is then, for each wheel, independently scaled to a desired actuator force using tunable gain factors.

The controller module 304 further incorporates a force stabilization control module 338. The force stabilization control module 338 has as its objective to reduce the transmission of force spikes into the vehicle body due to road surface inputs during cornering maneuvers. Based on the band-pass filtered calculated damper forces and on the band-pass filtered measured compression pressures, extra force requests which counteract these force or pressure variations are calculated for each damper 30a-30d individually. Tunable parameters are the time constants for the band-pass filters and the gain factors for the filtered actuator force and filtered compression pressure. The force stabilization control module 338 is only activated when the overall force request for that particular damper 30a-30d exceeds a tunable limit value.

The damper forces calculated by the modules 332-338 described above are all added together with the external force requests, taking into account the internal and external force arbitration, and sent to the management module 306. The operation of the management module 306 will be discussed further in the following paragraphs.

Local (Corner) Control of Vehicle

The controller module 304 further includes a wheel damping control module 340. The principal objective of the wheel damping control module 340 is to reduce high-frequency wheel shake. In this way the contact between the each of the vehicle's wheels and the road is more stable, resulting in a safer and more positive handling behavior for the vehicle 10. In addition, the reduction of wheel-shake also can provide a significant comfort improvement for the vehicle passengers, since less high-frequency forces are transmitted to the vehicle body.

The measured wheel accelerations are band-pass filtered by the wheel damping control module 340 so that only the frequency content related to the high-frequency wheel movements is retained. A non-linear look-up table is used to calibrate the sensitivity of the wheel damping control to the filtered wheel acceleration. The output of this look-up table is then, for each wheel, individually converted to CVSA valve control current offsets using separate gain factors for front rebound, front compression, rear rebound and rear compression. As an alternative, the CVSA valve control current offsets for the rear dampers can also be calculated based on the filtered wheel accelerations of the front axle. Still further, one or more digital valves (i.e., valves that are either fully “On” or fully “Off”) may be used at each damper 30a′-30d′, and one or more of the digital valves at each damper controlled through digital signals applied to the digital valves to produce the desired damper action. For the purpose of the following discussion, however, it will be assumed that CVSA style valves are being used, although the systems and methods of the present disclosure are fully usable with either style of valve.

End-stop Damping Control Module

The controller 304 also includes an end-stop damping control module 342. The principal objective of the end-stop damping control module 342 is to counteract the damper motion if the damper moves towards its travel limits. The measured damper displacements are band-pass filtered by the end-stop damping control module 342 so that only the frequency content related to the high-frequency wheel movements is retained. A non-linear look-up table is used to calibrate the sensitivity of the end-stop damping control module 342 to the filtered damper displacement. The output of this look-up table is then, for each wheel, individually converted to CVSA valve control current offsets using separate gain factors for front rebound, front compression, rear rebound and rear compression. The CVSA valve control current offsets calculated by the wheel damping control module 340 and the end-stop damping control module 342 are added together and sent to the management module 306 described in the following paragraphs.

The Management Module

A principal operation of the management module 306 is to translate the desired actuator force calculated by the controller module 304 into an appropriate set of control signals (e.g., power pack pump speed, CVSA valve control currents, switch valve control currents) to deliver a certain force request and to combine it with the CVSA valve control current offsets calculated by the wheel damping control module 340 and the end-stop damping control module 342 of the controller module 304. The management module 306 controls each damper 30a-30d in open loop mode: based on the force requests, a set of control signals is determined, without taking the actual damper velocity into account.

One particular advantage of the management module 306 is the inclusion of an active learning module 306a. The active learning module 306a enables the management module 306 to recognize certain combinations of inputs, whether they originate from sensors or user inputs, and to better and more effectively control the generation of output signals to meet real time driving conditions.

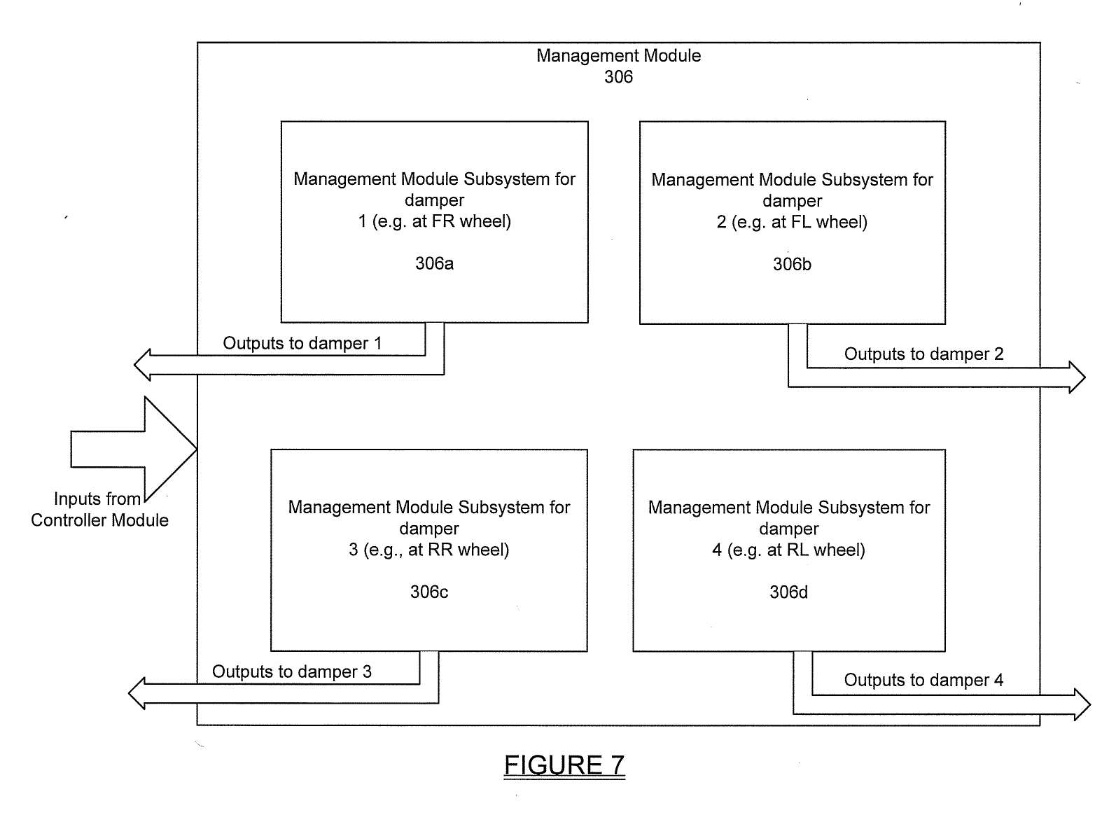

As shown in FIG. 7, the management module 306 is this example is made up of four independent management module subsystems 306a-306d. Each of the management module subsystems 306a-306d is independently associated with one specific damper from the group of dampers 30a-30d. So for example, management module subsystem 306a may be used to generate the outputs for controlling damper 30a, subsystem 306b may generate the outputs for controlling damper 30b, subsystem 306c may generate the outputs for controlling damper 30c, and subsystem 306d may generate the outputs for controlling damper 30d. Each of the management module subsystems 306a-306b may have its own processor and associated software, or the subsystems may share a single processor. The outputs generated by the management module 306, which are provided to each damper 30a-30d, are indicated in FIG. 5.

Determination of Power Pack Pump Speed

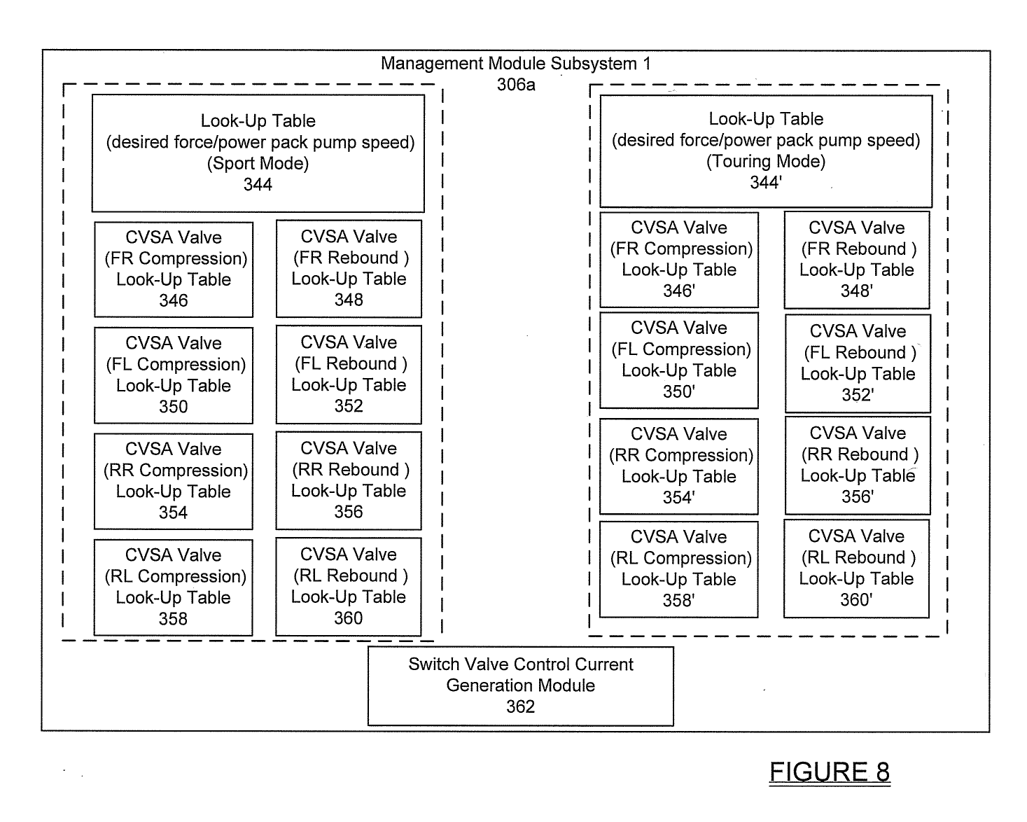

Referring to FIG. 8, a high level diagram of the subsystems present in management module subsystem 306a will be discussed. It will be appreciated that management module subsystems 306b-306d will each be of identical construction to management module subsystem 306a. The management module subsystem 306a makes use of a look-up table 344 which can be tuned differently for different operating modes. In this example the look-up table 344 is tuned for a “sport” mode of driving. Another look-up table 344′ may be tuned for a “touring” mode of driving. And while only two distinct driving modes are accommodated in this example, it will be appreciated that the system 300 may implement separate look-up tables 344 that provide for virtually any number of different driving modes. It will be appreciated that the “sport” mode may be a harder or stiffer (tightened) suspension feel that is provided by closing the valves associated with each of the dampers 30a′-30d′. The “sport” mode is named for the feel of a sports care that is designed for performance with respect to properties like acceleration and handling.

The look-up table 344 allows defining the relation between desired force and the power pack pump speed request with the goal of optimizing certain targets to achieve, in this example, a “sport” driving mode. For example, a different target may be optimizing ride comfort (i.e., use higher pump flow rates and lower CVSA valve control currents, which are suitable for the touring mode). Another target may be optimizing power consumption (i.e., use lower pump flow rates and higher CVSA valve control currents).

Determination of CVSA Valve Control Currents

Given a determined pump flow rate, the desired damper force will be achieved by controlling either the rebound CVSA valve control current to pull the vehicle body down or to pull the wheel up; or the compression CVSA valve control current to push the vehicle body up or to push the wheel down. For each CVSA valve a look-up table is trained to capture the needed level of control current to deliver a specific damper force. So in this example look-up table 346 provides the CVSA compression control current and look-up table 348 provides the rebound control current, for a given damper (e.g., damper 30a). For each driving mode, then, a total of four pairs of CVSA valve look-up tables 346-360 will be present to accommodate a system with four dampers 30a-30d. In this example the “touring” mode can also be seen to include a unique look-up table 344′ for force/power pack pump speeds 344′-348′, as well as four additional CVSA valve look-up tables 346′-360′. Each unique driving mode will have its own desired force/power pack pump speed look-up table and its own collection of four pairs of CVSA valve look-up tables.

In a final step, the CVSA valve control current offsets calculated by the wheel-damping control module 340 and the end-stop damping module 342 are summed together with the CVSA valve control currents calculated by the management module 306.

Each management module subsystem 306a-306d also includes its own switch valve control current generation module 362 for generating the needed switch valve control current. Separate switch valve control currents are generated by the management module subsystems 306a-306d and supplied to each damper 30a-30d (as also shown in FIG. 5).

Determination of Switch Valve Control Current

The management module 306 is also used to calculate the switch valve control current from the desired damper force by dividing the force request by a tunable reference force value, and applying a hyperbolic tangent function to generate a smooth transition from one direction to the other. If necessary, the resulting signal can be inverted to take into account the particular design of the hydraulics connecting to the switch valve on the damper (port 1 connected or rebound hydraulic circuit or compression hydraulic circuit). After that an offset and scaling gain factor are applied to shift and rescale the control signal to the correct current range for the switch valve.

Learning Feature

For each selected relationship between desired damper force and power pack pump speed, rebound and compression CVSA valve control current look-up tables can be trained to capture the relationship between desired damper force and CVSA valve control current. During such a training cycle, the desired damper force is increased step by step from 0 to the maximum static force for which the system 300 is sized, both in rebound and compression. For each step, the pump is set at the calibrated speed as described above (i.e., in “Determine of Pump Pack Speed”), and the appropriate (rebound or compression) CVSA valve control current is increased until the desired force level is reached. The damper force is calculated from the measured pressures as described in the above section involving “Processing of Power Pack CAN Signals”. At present this “Learning Feature” needs to be manually activated, but it could also be done automatically, for example during an initialization cycle at system commissioning or at the start of a service mode.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An active suspension system for a vehicle, wherein the vehicle has a plurality of active dampers and a plurality of sensors for providing information on operating states of the vehicle, comprising:
an estimator module configured to receive inputs from the plurality of sensors and to generate a plurality of first outputs including differing body accelerations during operation of the vehicle;
a controller module in communication with the estimator module and configured to receive the plurality of first outputs from the estimator module and to generate a plurality of second output signals for controlling the active dampers; and
a management module configured to receive the second output signals and to calculate actuator signals to be applied to each of the plurality of active dampers to implement a user selected ride condition.

2. The active suspension system of claim 1, wherein the first plurality of output signals generated by the estimator module includes at least two or more of the following:
signals relating to damper forces;
hydraulic power consumption;
wheel displacements, velocities and accelerations of a plurality of wheels of the vehicle;
damper displacements, velocities and accelerations;
pressures associated with a pump of the system and pressures associated with compression and rebound conditions of each of the active dampers;
body displacements, velocities and accelerations;
modal displacements, velocities and accelerations associated with heave, pitch and roll movements of the vehicle; and
vehicle and power pack signals.

3. The active suspension system of claim 1, wherein the inputs to the estimator module from the plurality of sensors comprises at least two or more of the following:
lateral acceleration of the vehicle;
brake pressure;
individual wheel speeds;
vehicle speed;
throttle pedal position;
steering wheel angle;
steering wheel angle rate;
brake torque (request);
engine torque (request) and
engine revolutions per minute (RPM).

4. The active suspension system of claim 1, wherein the second plurality of outputs include, for each said active damper:
a damper force;
a control current offset for a compression phase of operation of the active damper;
a control current offset for a rebound phase of operation of the active damper.

5. The active suspension system of claim 1, wherein the actuator signals generated by the management module comprise at least one or more of the following:
switch valve control current signals;
power pack pump speed signals; and
valve control currents for rebound and compression phases of operation of each said active damper.

6. The active suspension system of claim 1, wherein the controller module includes a skyhook control module including:
a first non-linear look-up table having as its input a modal heave velocity and as an output a gain factor multiplied by a linear gain to enable a sensitivity of a modal heave force to be adjusted over a range of a modal heave velocity.

7. The active suspension system of claim 6, wherein the controller module includes a skyhook control module including:
a second non-linear look-up table having as an input vehicle velocity, and as an output a gain factor multiplied with an output from the first non-linear look-up table, to enable the modal heave force to be a function of a velocity of the vehicle.

8. The active suspension system of claim 7, wherein the skyhook control module further includes a plurality of additional look-up tables pertaining to a subplurality of:
roll displacements;
pitch displacements;
heave displacements;
heave velocities;
heave accelerations;
roll velocities;
roll acceleration;
pitch velocities; and
pitch accelerations.

9. The active suspension system of claim 1, wherein the controller module further includes at least a subplurality of:
a feed-forward module for calculating a desired pitch moment based on sensed brake pressure and vehicle velocity;
a modal based feed forward control module for calculating actuator forces at each wheel of the vehicle necessary to achieve a target pitch angle with respect to longitudinal acceleration and a target roll angle with respect to lateral acceleration;
a road preview module for calculating desired actuator forces for controlling each said active damper based on road preview information, wherein the road preview information involves characteristics pertaining to a road profile in front of the vehicle while the vehicle is moving;
a force stabilization control module configured to reduce a transmission of force spikes into a body of the vehicle from a road surface during cornering maneuvers of the vehicle;
a wheel damping control module for reducing high frequency wheel shake of a wheel of the vehicle; and
an end stop damping control module configured to counteract a motion of one of the active dampers if the one said active damper moves toward its travel limits.

10. The active suspension system of claim 1, wherein the management module includes a separate management module subsystem for each one of four active dampers.

11. The active suspension system of claim 10, wherein each one of the management module subsystems includes a look-up table for implementing a sport mode of tuning its associated said active damper.

12. The active suspension system of claim 10, wherein each one of the management module subsystems includes a look-up table for implementing a touring mode of tuning its associated said active damper.

13. The active suspension system of claim 11, wherein the lookup table of the management module subsystem includes separate look-up tables for valves associated with the plurality of active dampers, and wherein the look-up tables are directed to valve values for compression or rebound phases of operation of the active dampers to implement the sport mode of tuning.

14. The active suspension system of claim 12, wherein the lookup table of the management module subsystem includes separate look-up tables for valves associated with the plurality of active dampers, and wherein the look-up tables are directed to valve values for compression or rebound phases of operation of the active dampers to implement the touring mode of tuning.

15. An active suspension system for a vehicle having four active dampers and a plurality of sensors for providing information on a plurality of states of the vehicle, comprising:
an estimator module configured to receive inputs from the plurality of sensors and to generate a plurality of first outputs relating to accelerations associated with operation of the vehicle;
a controller module in communication with the estimator module and configured to receive the plurality of first outputs from the estimator module and to generate a plurality of second output signals for controlling the active dampers; and
a management module configured to receive the second outputs and to calculate actuator signals to be applied to each one of the plurality of active dampers, the management module including:
a separate management module subsystem for each said active damper, each said management module subsystem including:
a first look-up table for valve control values for controlling at least one valve associated with each of the active dampers to implement a sport mode of operation for the active dampers; and
a second look-up table for valve control values for controlling at least one valve associated with each of the active dampers to implement a touring mode of operation for the active dampers.

16. The active suspension system of claim 15, wherein the controller modules includes:
a first non-linear look-up table having as its input a modal heave velocity and as an output a gain factor multiplied by a linear gain to enable a sensitivity of a modal heave force to be adjusted over a range of a modal heave velocity; and
a second non-linear look-up table having as an input vehicle velocity, and as an output a gain factor multiplied with an output from the first non-linear look-up table, to enable the modal heave force to be a function of a velocity of the vehicle.

17. The active suspension system of claim 15, wherein the controller module further includes at least a subplurality of:
a feed-forward module for calculating a desired pitch moment based on sensed brake pressure and vehicle velocity;
a modal based feed forward control module for calculating actuator forces at each wheel of the vehicle necessary to achieve a target pitch angle with respect to longitudinal acceleration and a target roll angle with respect to lateral acceleration;
a road preview module for calculating desired actuator forces for controlling each said active damper based on road preview information, wherein the road preview information involves characteristics pertaining to a road profile in front of the vehicle while the vehicle is moving;
a force stabilization control module configured to reduce a transmission of force spikes into a body of the vehicle from a road surface during cornering maneuvers of the vehicle;
a wheel damping control module for reducing high frequency wheel shake of a wheel of the vehicle; and
an end stop damping control module configured to counteract a motion of the active damper if the active damper moves toward its travel limits.

18. A method for forming an active suspension system for a vehicle, wherein the vehicle has a plurality of active dampers and a plurality of sensors for providing information on operating states of the vehicle, comprising:
using an estimator module configured to receive inputs from the plurality of sensors and to generate a plurality of first outputs including differing body accelerations during operation of the vehicle;
using a controller module in communication with the estimator module and configured to receive the plurality of first outputs from the estimator module and to generate a plurality of second output signals for controlling the active dampers; and
using a management module configured to receive the second outputs and to calculate actuator signals to be applied to each of the plurality of active dampers.
